(19) United States
(12) Patent Application Publication
(10) Pub. No.: US 2026/0369787 A1
(43) Pub. Date: Nov. 19, 2026

(54) SOLID-STATE BATTERY ASSEMBLY AND DIMPLED FASTENER CONNECTOR ASSEMBLY

(71) Applicant: Schaeffler Technologies AG & Co. KG, Herzogenaurach (DE)

(72) Inventors: Tuo Luo, Copley, OH (US); Kyle DeHoff, Mogadore, OH (US)

(73) Assignee: Schaeffler Technologies AG & Co. KG, Herzogenaurach (DE)

(21) Appl. No.: 19/665,556

(22) Filed: May 1, 2026

Related U.S. Application Data
(60) Provisional application No. 63/806,331, filed on May 15, 2025.

(51) Int. Cl. H01M 50/262; H01M 50/209; H01M 50/224; H01M 50/293; F16B 23/00

(52) U.S. Cl. CPC H01M 50/262; H01M 50/209; H01M 50/224; H01M 50/293; F16B 23/0038

(57) ABSTRACT

A solid-state battery assembly includes first and second end plates, each having tapered countersink holes with a tapered entry leading to a threaded hole, a plurality of solid-state battery cells stacked between the first and second end plates, and a housing. The housing includes a front and rear shell plates, each having opposite first and second ends connected to the first and second end plates. A plurality of fastener connectors connect the first shell plate to the first and second end plates and the second shell plate to the first and second end plates. Each fastener connector has a spacer disposed within one of the tapered countersink holes of one of the first and second end plates. A fastener is included having a head at one end and threads at an opposite end matingly engaged within the threaded hole of one of the first and second end plates.

### CROSS-REFERENCE TO RELATED APPLICATIONS

This application claims priority to U.S. 63/806,331, filed on May 15, 2025, entitled “DIMPLED BOLT CONNECTION TO CARRY SHEAR FORCE AND REDUCE OVERHEAD SPACE REQUIREMENT FOR SOLID-STATE BATTERY PACK,” the disclosure of which is hereby incorporated herein by reference in its entirety.

### FIELD OF THE DISCLOSURE

The present disclosure generally relates to a dimpled fastener connection assembly, and more particularly relates to a solid-state battery assembly having a dimpled fastener connection assembly.

### BACKGROUND OF THE DISCLOSURE

A solid-state battery pack typically experiences variable pressure applied in through the thickness direction of the stacked cells to compensate for battery charging state caused thickness change and aim to maintain suitable contact pressure across layers of battery material to keep good interlayer conductivity. The shell of the battery packet generally needs to withstand this pressure/force and maintain its structural integrity. One challenge with current designs is the battery shell, also acting as the internal pressure bearing component, has to be strong enough to carry this axial load within a certain thickness limit while keeping the exterior side of the battery shell substantially flush.

The example joints connecting a battery pack shell plate and a connecting base block which is typically a fixed end plate generally is required to carry high shear force and the design envelop may not have headspace for designs with fastener heads that are not substantially flush with shell plate. Previous designs of a shell plate with a bend to wrap around the base block may suffer durability issues from high tensile stress (800-1100MPa) on the bending corner.

### SUMMARY OF THE DISCLOSURE

According to a first aspect of the present disclosure, a solid-state battery assembly includes first and second end plates, each having tapered countersink holes with a tapered entry leading to a threaded hole, a plurality of solid-state battery cells stacked between the first and second end plates, and a housing including a front shell plate and a rear shell plate. The front and rear shell plates each have opposite first and second ends connected to the first and second end plates, each of the first and second shell plates having a plurality of dimpled cone-shaped holes. A plurality of fastener connectors connect the first shell plate to the first and second end plates and connect the second shell plate to the first and second end plates. Each of the fastener connectors comprise a spacer disposed within one of the tapered countersink holes of one of the first and second end plates. The spacer includes a tapered outer wall that conforms to the shape of a tapered entry to the countersink hole and having a spacer hole extending therethrough, and a fastener having a head at one end and threads at an opposite end matingly engaged within the threaded hole of one of the first and second end plates.

Embodiments of the first aspect of the disclosure can include any one or a combination of the following features:
the dimpled cone-shaped hole, the tapered outer wall of the spacer and the tapered entry extend at an angle in the range of 20° to 60°;
the angle is in the range of 30° to 50°;
the angle is about 45°;
the fastener is flush-mounted within the one of the front and rear shell plates;
the spacer comprises metal;
the housing comprises metal;
the first and second shell plates each comprise steel;
the fastener comprises a non-threaded shaft between the head and the threads; and
dimpled cone-shaped holes are formed in the front and rear shell plates by drilling or punching.

According to a second aspect of the present disclosure, a dimpled fastener connector assembly for connecting a shell plate onto a base block includes a dimpled cone-shaped hole in the shell plate, a threaded hole provided in the base block and having a tapered entry, a spacer disposed within the countersink opening and having a tapered outer wall conforming to the dimpled cone-shaped hole and the tapered entry, and a threaded fastener having a head at one end and threads at an opposite end extending through the spacer and the dimpled cone-shaped hole in the shell plate and into the threaded hole in the base block.

Embodiments of the first aspect of the disclosure can include any one or a combination of the following features:
the dimpled cone-shaped hole, the tapered outer wall of the spacer and the tapered entry extend at an angle in the range of 20° to 60°;
the angle is in the range of 30° to 50°;
the angle is about 45°;
the fastener is flush-mounted within the shell plate;
the spacer comprises metal;
the housing comprises metal;
the first and second shell plates each comprise steel;
the dimpled cone-shaped hole is formed in the front and rear shell plates by drilling or punching; and
the dimpled fastener connector assembly comprises a plurality of threaded fasteners, a plurality of cone-shaped holes, a plurality of threaded holes and a plurality of spacers.

These and other features, advantages, and objects of the present disclosure will be further understood and appreciated by those skilled in the art by reference to the following specification, claims, and appended drawings.

### BRIEF DESCRIPTION OF THE DRAWINGS

The present disclosure is described below by reference to the following drawings, in which:

FIG. 1 is a schematic diagram of a battery powered device having a solid-state battery assembly, according to one example;

FIG. 2 is a front perspective view of the solid-state battery assembly having a plurality of battery cells stacked in a module having housing shell plates and dimpled fastener connectors for connecting the shell plates onto the fixed end plates, according to one example;

FIG. 2A is an exploded front perspective view of the solid-state battery assembly shown in FIG. 2;

FIG. 3 is an enlarged view of section III of FIG. 2 showing the dimpled fastener connectors of the battery shell plate flush-mounted onto the shell plate and base block which serve as a fixed end plate, according to one example;

FIG. 3A is an exploded view of the dimpled fastener connectors shown in FIG. 3;

FIG. 4 is a cross-sectional view taken through line IV-IV of FIG. 3 further illustrating the flush mounted dimpled fastener connection;

FIG. 4A is an exploded view of the dimpled fastener connection shown in FIG. 4; and

FIG. 5 is a sectional view of a dimpled fastener connection assembly with a non-flush fastener according to another example.

The components in the figures are not necessarily to scale, emphasis instead being placed upon illustrating the principles described herein.

### DETAILED DESCRIPTION

Additional features and advantages of the disclosure will be set forth in the detailed description which follows and will be apparent to those skilled in the art from the description, or recognized by practicing the disclosure as described in the following description, together with the claims and appended drawings.

As used herein, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination.

In this document, relational terms, such as “first” and “second,” “top” and “bottom,” and the like, are used solely to distinguish one entity or action from another entity or action, without necessarily requiring or implying any actual such relationship or order between such entities or actions.

For purposes of this disclosure, the term “coupled” (in all of its forms: couple, coupling, coupled, etc.) generally means the joining of two components (electrical or mechanical) directly or indirectly to one another. Such joining may be stationary in nature or movable in nature. Such joining may be achieved with the two components (electrical or mechanical) and/or any additional intermediate members. Such joining may include members being integrally formed as a single unitary body 38 with one another (i.e., integrally coupled) or may refer to joining of two components. Such joining may be permanent in nature, or may be removable or releasable in nature, unless otherwise stated.

The terms “substantial,” “substantially,” and variations thereof as used herein are intended to note that a described feature is equal or approximately equal to a value or description. For example, a “substantially planar” surface is intended to denote a surface that is planar or approximately planar. Moreover, “substantially” is intended to denote that two values are equal or approximately equal. In some embodiments, “substantially” may denote values within about 10% of each other, such as within about 5% of each other, or within about 2% of each other.

As used herein, the terms “the,” “a,” or “an,” mean “at least one,” and should not be limited to “only one” unless explicitly indicated to the contrary. Thus, for example, reference to “a component” includes embodiments having two or more such components unless the context clearly indicates otherwise.

The following description of the preferred embodiment is merely exemplary in nature and is in no way intended to limit the invention, its application, or uses. Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

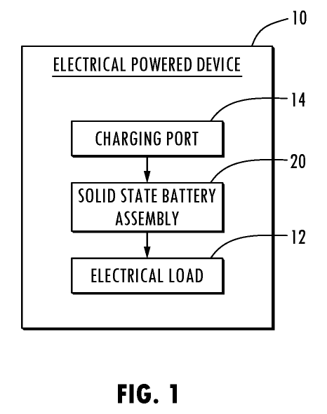

As shown in FIGS. 1-5, a dimpled fastener connector assembly 34 and a solid-state battery 20 having a dimpled fastener connector assembly 34 are generally shown and described herein. The solid-state battery assembly 20 comprises first and second end plates 24 and 26, a plurality of solid-state battery cells 28 stacked between the first and second end plates 24 and 26, and a housing including a first shell plate 30 and a second shell plate 32, wherein the first and second shell plates 30 and 32 each have opposite first and second ends connected to the first and second end plates 24 and 26. Each of the first and second end plates 24 and 26 have tapered countersink holes 52 with a tapered entry, and each of the first and second shell plates 30 and 32 have a plurality of dimpled cone-shaped holes 60. The battery 20 includes a plurality of dimpled fastener connectors 35 connecting the first shell plate 30 to the first and second end plates 24 and 26, and connecting the second shell plate 32 to the first and second end plates 24 and 26. Each of the dimpled fastener connectors 35 comprises a spacer 42 supported within one of the tapered countersink holes 52 of one of the first and second end plates 24 and 26, wherein the spacer 42 includes a tapered outer wall 62 that conforms to the shape of the tapered entry 50 and has a spacer counter sinkhole 64 extending therethrough, and a fastener 44 having a head 74 at one end and threads 56 matingly engaged within threads within a threaded hole 54 of one of the first and second end plates 24 and 26.

Referring to FIG. 1, an electrical powered device 10 is generally illustrated having a solid-state battery assembly 20, also referred to as an all solid-state battery (ASSB) assembly. The electrical powered device 10 may include an electric vehicle, such as a battery-powered electric vehicle or a hybrid vehicle, for example, employing one or more solid-state batteries 20 to power one or more electrical loads, such as one or more electric motors. For a vehicle application, the battery assembly 20 may output a high voltage such as 400 volts or 800 volts, for example. The electrical powered device 10 may otherwise be configured as a portable electronic device or a humanoid, such as a robot, for example, that has one or more electrical loads. The solid-state battery assembly 20 is a rechargeable solid-state battery assembly 20 having a stacked arrangement of solid-state battery cells that may be electrically charged using a charging port 14 that receives and supplies electricity with a charging voltage to charge the solid-state battery assembly 20.

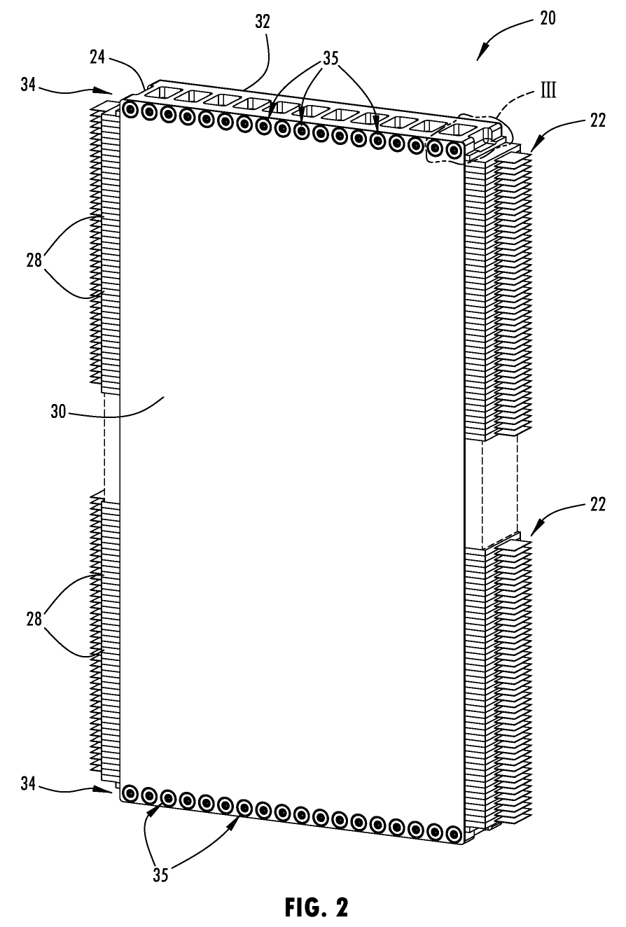

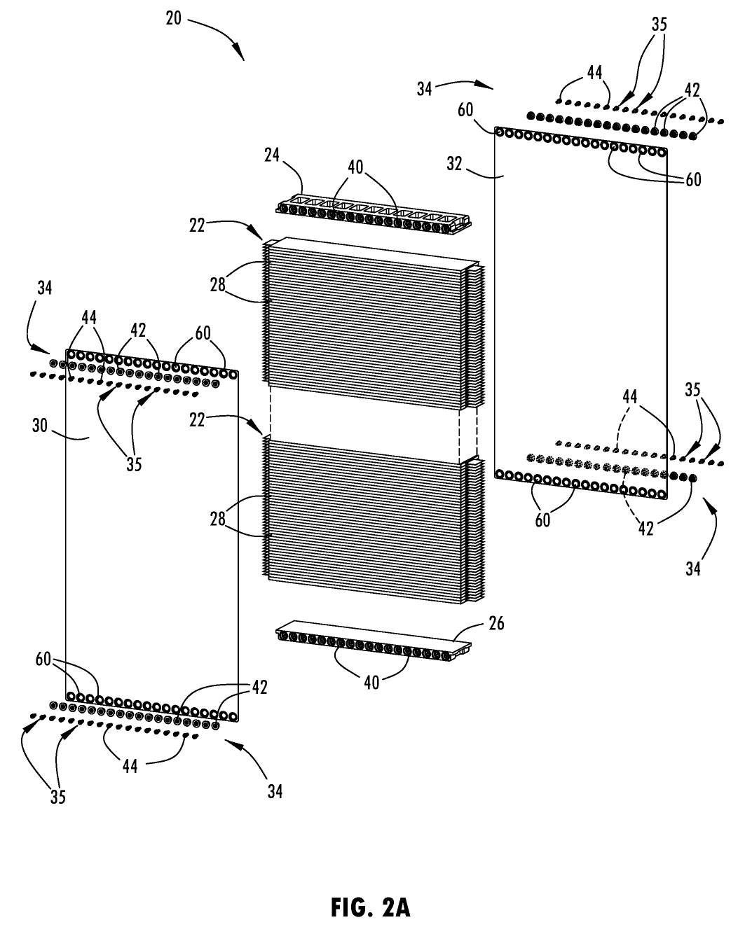

The solid-state battery assembly 20 having a dimpled fastener connector assembly is shown in FIGS. 2-4A, according to one embodiment. The battery assembly 20 is an all solid-state battery assembly packaged as a module having a housing with shell plates and a plurality of solid-state battery cells 28 stacked one on top another in a stacked arrangement. The battery assembly 20 has a front first shell plate 30, a rear second shell plate 32, and first and second fixed end plates 24 and 26 that define a frame or housing that supports the battery cells 28 and covers at least a portion of the battery cells 28. The first and second shell plates 30 and 32 extend between opposite top and bottom ends where they are connected to the fixed end plates 24 and 26 with a dimpled fastener connector assembly 34 having a plurality of dimpled fastener connectors 35, such that the first and second end plates 24 and 26 are fixed relative to each other.

The battery cells 28 are solid-state battery cells, and the stacked arrangement may include two or more solid-state battery cells 28. The battery cells 28 generally include an anode and a cathode and are configured in one example having a length and width defining a rectangular shape and a relatively thin thickness. The battery cells 28 include positive and negative contact terminals which may be located on opposite ends. The solid-state battery cells 28 generally expand and contract in thickness during charging and discharging cycles which is the result of ions moving within the electrode material. For example, lithium ions may move from the cathode to the anode during charging, thereby causing the anode material to expand. During discharging of the battery cells 28, the reverse movement of the ions happens and the anode contracts. The first and second end plates 24 and 26 are fastened to the first and second shell plates 30 and 32. This may be achieved by using the dimpled fastener connector assembly 34 shown and described herein.

To accommodate the changes in expansion and contraction of the battery cells 28 and the resulting axial load, the solid-state battery assembly 20 may be configured with one or more stacks 22 of battery cells 28 and may include axial load control such as a spring-like assembly, for example, that manages the pressure between the first and second end plates 24 and 26 to create a controlled pressure. The first and second end plates 24 and 26 are fixed to the first and second shell plates 30 and 32 such that they do not move relative to one another and generally are rectangular in shape with a size similar to the length and width of the battery cells 28. As such, the first and second shell plates 30 and 32 hold the first and second end plates 24 and 26 in a fixed position relative to each other via the dimpled fastener connection. The first and second shell plates 30 and 32 and the first and second end plates 24 and 26 may be formed of metal, for example. The first end plate 24 extends over the top end of the battery cells 28, and the second end plate 26 extends below the bottom end of the battery cells 28.

The plurality of battery cells 28 within the stack 22 are generally stacked one on top another and may include a compliant material layer disposed between adjacent battery cells 28. Compliant material layers may also be located between the upper surface of the top most battery cell 28 and between the bottom most battery cell 28 and the upper surface of the second end plate 26. The compliant material may include a thin sheet or mat made of polyurethane or rubber, for example. It should be appreciated that heating mats or cooling loops may also be slotted between cell stacks.

The solid-state battery assembly 20 includes a dimpled fastener connector assembly 34 that has a plurality of dimpled fastener connectors 35 connecting the first shell plate 30 on the front side to the first and second end plates 24 and 26 and connecting the second shell plate 32 on the rear side to the first and second end plates 24 and 26. As such, the first and second shell plates 30 and 32 hold the first and second end plates 24 and 26 in a fixed relationship.

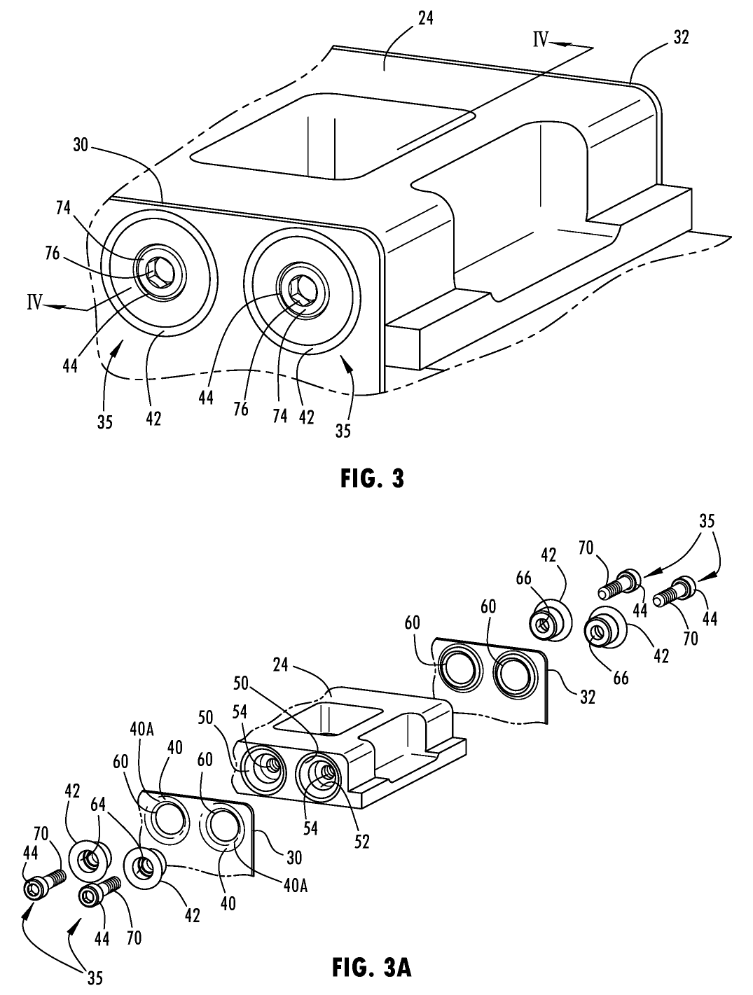

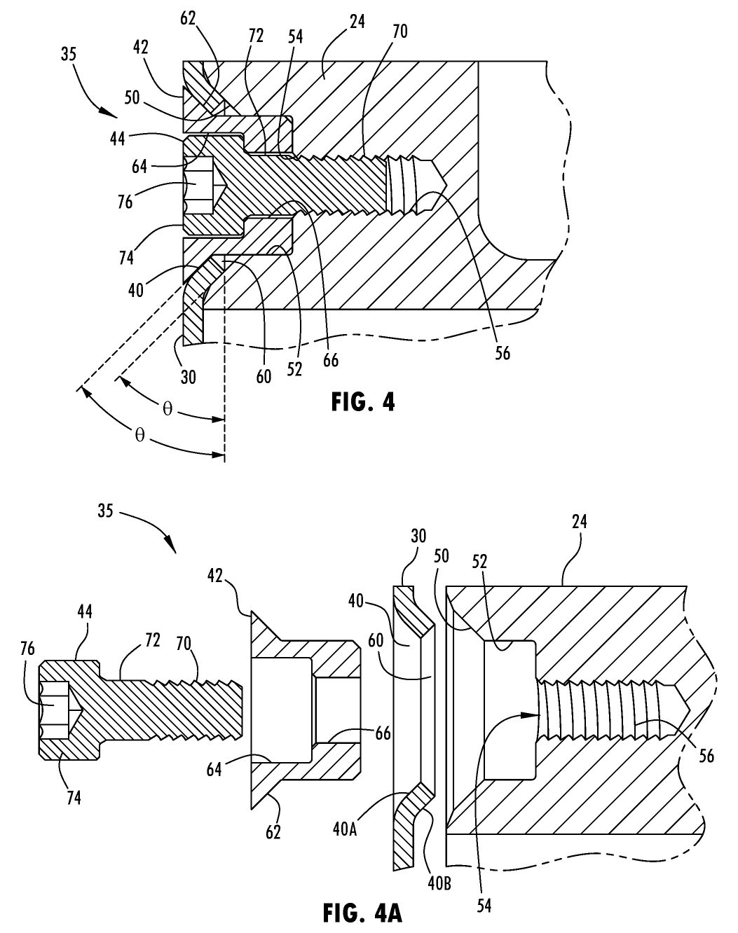

Each of the dimpled fastener connectors 35 may be configured as shown in more detail in FIGS. 3-4A. The dimpled fastener connector 35 includes a fastener 44 and a spacer 42 extending through a dimpled cone-shaped hole 60 in the shell plate 30 and into engagement with a threaded hole 54 in the end plate 24. The spacer 42 is disposed within the dimpled cone-shaped hole 60 having a frustoconical or cone-shaped angled portion 40 formed in one of the first and second shell plates 30 and 32. The cone-shaped angled portion 40 has an outer surface 40A and an inner surface 40B, both oriented at an angle θ. The fastener 44 and spacer 42 further extend within a countersink hole 52 in one of the first and second end plates 24 and 26. The countersink hole 52 has a tapered entry 50 with a frustoconical shape that receives the dimpled cone-shaped angled portion 40 which receives the spacer 42. The spacer 42 includes a frustoconical exterior portion at one end with an outer surface that conforms to the shape of the cone-shaped angled portion 40 of the dimpled cone-shaped hole 60 and tapered entry 50, such that the spacer 42, shell plate 30 and end plate 24 fit together along angle θ. The spacer 42 may be made of metal and includes a spacer counter sinkhole 64 on the interior that leads to a narrower fastener shaft hole 66. The fastener 44 extends through the fastener shaft hole 66 in the spacer 42, the dimpled cone-shaped hole 60 with the cone-shaped angled portion 40 in the shell plate 30, and into threaded engagement with threads 56 in threaded hole 54 in the end plate 24 as shown in FIGS. 4 and 4A. Each dimpled fastener connector 35 has a fastener 44 and a spacer 42 matingly engaged to the dimpled cone-shaped hole 60 in the shell plate 30 and the threaded hole 54 in the end plate 24.

The dimpled fastener connector 35 is assembled with the battery shell plate 30 or 32 with the dimpled cone-shaped hole 60 in the middle for receiving the fastener 44 and the spacer 42. The end plate 24 or 26 serves as a base block and has the countersink hole 52 with the tapered entry 50 configured at angle θ to match the angled θ on the bottom side of the dimpled cone-shaped angle portion 40 on the shell plate 30 or 32, the spacer 42 with matching surface 62 with the top of shell plate dimple, and the fastener 44. The dimpled cone-shaped angle portion 40 on the battery shell 30 or 32 has a frustoconical shape on both the exterior surface 40A and the interior surface 40B and can be made by forming or using a squeezing tool and then drilling a hole in the middle or directly punching out the geometry of the dimple and hole. The countersink hole 52 with the tapered entry 50 and the outer surface of the spacer 42 can be machined to match the dimpled cone-shaped angled portion 40. The dimpled fastener connector 35 prevents or reduces fastener head slippage due to shear force caused by the axial load. Compared to a conventional double lap bolt shear joint, this dimpled joint may only need 50% preload to prevent bolt head slipping under same shear force.

Referring particularly to FIGS. 4 and 4A, the dimpled fastener connector assembly 34 is shown with each dimpled fastener connector 35 assembled within the base block which is provided by either the first end plate 24 or the second end plate 26 with a flush mounted head 74 of the fastener 44, such that the fastener 44 does not extend outward from the fastener side of the first end plate 24. The fastener 44 may be configured as a screw, in one example, having a threaded portion with threads 70 matingly configured to engage threads 56 within the threaded hole 54 of the first end plate 24. The fastener 44 has a threaded shaft at one end, a head 74 at the opposite end, and a non-threaded shaft 72 in between the opposite ends. The fastener 44 may be configured as a bolt, according to another example.

To assemble, the battery shell 30 is formed with the dimpled cone-shaped hole 60, each having a cone-shaped angled portion 40 at an angle θ of approximately 20°-60°, and more particularly 30°-50°, and more particularly about 45°, according to one example. The spacer 42 having a flared end with outer tapered wall 62 at angle θ that matingly matches the shape of the cone-shaped angled portion 40 in the battery shell 30, such as an angle of θ in the range of 20°-60°, is inserted within the dimpled cone-shaped angled portion 40 of the battery shell 30 and further within the countersink portion 52 of the end plate 24. The fastener 44 is then rotated with a tool, such as a drill having a shaped bit, engaging the hex head 76 at the head end 74 to screw in the fastener 44 into engagement with the threaded hole 54 in the end plate 24. By providing the cone-shaped angled portion 40 of the dimpled cone-shaped hole 60 and matching conical entry 50 and mating tapered outer wall 62, all oriented at angle θ, the dimpled fastener connector assembly 34 advantageously provides for enhanced shear strength that may receive shear loads which may be directed laterally and transferred at angle θ. As a result, a reduced diameter fastener and fewer fasteners may be employed to retain the shell plates 32 connected to the end plates 24 and 26 to withstand the axial load as the battery cells expand and contract.

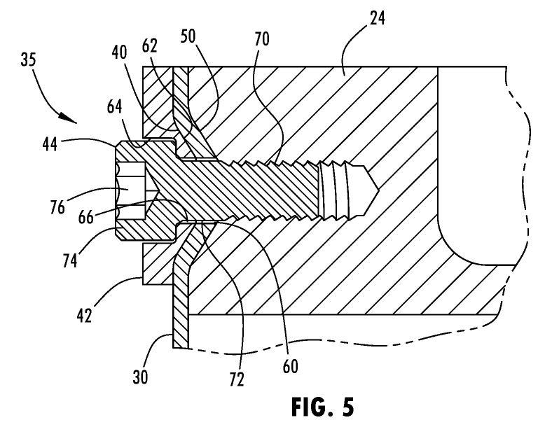

Referring to FIG. 5, a dimpled fastener connector 35 is shown according to another example, in which the fastener 44, once assembled, extends partly outside of the shell plate 32, such that the fastener head 74 is not completely flush with the outer surface of the shell end plate 30. It should be appreciated that the fastener 44 may be flush mounted or may extend partly outwards from the outer surface of the battery shell plate 30 as shown in FIG. 5. It should be appreciated that the dimpled fastener connector assembly 34 may have a common spacer 42 that extends over multiple dimpled fastener connectors 35.

This disclosure features a dimpled fastener connector assembly 34 to sink the bolt head 74 of the fastener 44 into the base block so that the bolt head 74 is flush or nearly flush with the shell plate 32, in one example, and has the additional benefit of being capable of carrying higher shear force with less fastener preload so that a smaller fastener can be used. The dimpled fastener connector 35 features a dimpled cone-shaped hole 60 and countersink hole 52 in the base block to keep the top of the shell plate 32 flush. Additionally, this geometry achieves no fastener head slip (therefore, no bolt loosening risk) with much lower preload. For example, assuming a coefficient of friction (COF) of 0.1, the dimpled fastener connector assembly 34 may carry 3kN with 13.7kN bolt preload and features at least a 50% reduction in needed fastener preload.

Due to its shear carrying enhancement, the dimpled fastener connector assembly 34 has the potential to apply to other applications that are tight in space but need to carry high shear force, e.g., e-axle housing or other structural components.

The description of the disclosure is merely exemplary in nature and, thus, variations that do not depart from the gist of the disclosure are intended to be within the scope of the disclosure. Such variations are not to be regarded as a departure from the spirit and scope of the disclosure.

It is to be understood that variations and modifications can be made on the afore-mentioned structure without departing from the concepts of the present disclosure, and further it is to be understood that such concepts are intended to be covered by the following claims unless these claims by their language expressly state otherwise.

### LIST OF REFERENCE NUMERALS

10 electrical powered device
14 charging port
20 solid-state battery assembly
22 stacks
24 first end plate
26 second end plate
28 battery cells
30 first shell plate
32 second shell plate
34 dimpled fastener connector assembly
35 dimpled fastener connectors
38 single unitary body
40 cone-shaped angled portion
40A frustoconical shape side
40B frustoconical shape side
42 spacer
44 fastener
50 tapered entry
52 countersink hole
54 threaded hole
56 threads
60 dimpled cone-shaped hole
62 tapered outer wall
64 spacer counter sinkhole
66 fastener shaft hole
70 threads
74 flush mounted head
76 hex head

What is claimed is:

1. A solid-state battery assembly comprising:
first and second end plates, each having tapered countersink holes with a tapered entry leading to a threaded hole;
a plurality of solid-state battery cells stacked between the first and second end plates;
a housing including a front shell plate and a rear shell plate, wherein the front and rear shell plates each have opposite first and second ends connected to the first and second end plates, each of the first and second shell plates having a plurality of dimpled cone-shaped holes; and
a plurality of fastener connectors connecting the first shell plate to the first and second end plates and connecting the second shell plate to the first and second end plates, each of the fastener connectors comprising:
a spacer disposed within one of the tapered countersink holes of one of the first and second end plates, wherein the spacer includes a tapered outer wall that conforms to the shape of a tapered entry to the countersink hole and has a spacer hole extending therethrough; and
a fastener having a head at one end and threads at an opposite end matingly engaged within the threaded hole of one of the first and second end plates.

2. The battery assembly of claim 1, wherein the dimpled cone-shaped hole, the tapered outer wall of the spacer and the tapered entry extend at an angle in the range of 20° to 60°.

3. The battery assembly of claim 2, wherein the angle is in the range of 30° to 50°.

4. The battery assembly of claim 3, wherein the angle is about 45°.

5. The battery assembly of claim 1, wherein the fastener is flush-mounted within the one of the front and rear shell plates.

6. The battery assembly of claim 1 wherein the spacer comprises metal.

7. The battery assembly of claim 6 wherein the housing comprises metal.

8. The battery assembly of claim 7, wherein the first and second shell plates each comprise steel.

9. The battery assembly of claim 1, wherein the fastener comprises a non-threaded shaft between the head and the threads.

10. The battery assembly of claim 1, wherein dimpled cone-shaped holes are formed in the front and rear shell plates by drilling or punching.

11. A dimpled fastener connector assembly for connecting a shell plate onto a base block, the dimpled fastener connector assembly comprising:
a dimpled cone-shaped hole in the shell plate;
a threaded hole provided in the base block and having a tapered entry;
a spacer disposed within the countersink opening and having a tapered outer wall conforming to the dimpled cone-shaped hole and the tapered entry; and
a threaded fastener having a head at one end and threads at an opposite end extending through the spacer and the dimpled cone-shaped hole in the shell plate and into the threaded hole in the base block.

12. The dimpled fastener connector assembly of claim 11, wherein the dimpled cone-shaped hole, the tapered outer wall of the spacer and the tapered entry extend at an angle in the range of 20° to 60°.

13. The dimpled fastener connector assembly of claim 12, wherein the angle is in the range of 30° to 50°.

14. The dimpled fastener connector assembly of claim 13, wherein the angle is about 45°.

15. The dimpled fastener connector assembly of claim 13, wherein the fastener is flush-mounted within the shell plate.

16. The dimpled fastener connector assembly of claim 11 wherein the spacer comprises metal.

17. The dimpled fastener connector assembly of claim 16 wherein the housing comprises metal.

18. The dimpled fastener connector assembly of claim 17, wherein the first and second shell plates each comprise steel.

19. The dimpled fastener connector assembly of claim 11, wherein the dimpled cone-shaped hole is formed in the front and rear shell plates by drilling or punching.

20. The dimpled fastener connector assembly of claim 11, wherein the dimpled fastener connector assembly comprises a plurality of threaded fasteners, a plurality of cone-shaped holes, a plurality of threaded holes and a plurality of spacers.
